(19) United States
(12) Patent Application Publication
(10) Pub. No.: US 2011/0180191 A1
(43) Pub. Date: Jul. 28, 2011

(54) UNDULATED PROGRESSIVE TIRE MOLD ELEMENT

(75) Inventor: Damon L. Christenbury, Fountain Inn, SC (US)

(73) Assignee: Michelin Recherche et Technique S.A., Granges-Paccot (CH)

(21) Appl. No.: 13/122,457

(22) PCT Filed: Oct. 3, 2008
(86) PCT No.: PCT/US08/78717

§ 371 Date: Apr. 4, 2011

(51) Int. Cl. B60C 11/12; B29D 30/00

(52) U.S. Cl. 152/209.18; 425/28.1

(57) ABSTRACT

Particular embodiments of the present invention include an undulating sipe mold member (10) and a corresponding sipe formed within a tire tread. In a particular embodiment, the present invention includes an undulating sipe mold member 10) for use in a mold, the mold member comprising: an upper mold member (12) extending downwardly from a top end to a bottom end; and, a first lower projection member (14) and a second lower projection member(16), each lower member extending downward from the initial extension, the sipe mold member (10) having a sweep axis along which the sipe mold member undulates in a desired path.

### BACKGROUND OF THE INVENTION

1. Field of the Invention

This invention relates generally to tire treads and molds, and, more specifically, to undulated, progressive tread sipes and methods and apparatus of forming the same.

2. Description of the Related Art

It is commonly known to for tire treads to contain various tread elements and features to enhance tire performance. It is also commonly known that these elements and features may be formed within a mold during a curing process. Treads may be formed and cured independently, such as for retreading, or concurrently with an attached tire carcass.

Grooves and sipes are two common tread features that are formed within a tread. Grooves are troughs formed within the tread to form tread elements, such as ribs and blocks. Sipes are very thin extensions that generally extend within the tread elements. Grooves provide void within the tread for the consumption of water and other substances encountered by the tire. Grooves also provide surface edges to improve tire traction. Sipes also provide traction edges, while further reducing tread element stiffness. Sipes, however, achieve their purposes generally without materially increasing the tread void. This is because sipes are very thin extensions, which, for conventional straight sipes, are typically 0.2-0.6 millimeters (mm) thick; however, sipes can measure upwards of 1.0-1.2 mm thick. It is desirous, however, to provide sipes that are as thin as possible to minimize the formation and existence of void.

Progressive sipes generally provide an upper sipe portion extending from an outer surface of the tread to a particular depth within the tread, after which a pair of lower sipe projections (or legs) extend downwardly into the tread from the first portion. At least one of the lower projections also extends outwardly from the other while extending into the tread depth. Generally, progressive sipes appear in cross-section as an inverted “Y”, such as is generally shown in U.S. Pat. No. 4,994,126. When molding a tire tread, a mold form or member is used to create a progressive sipe in such tread, where such mold member provides the cross-sectional shape of the sipe to be created. Because progressive sipes have outwardly extending projections, progressive sipe mold members contain similar projections. Accordingly, corresponding mold members generally experience elevated loads during molding and demolding operations due to the existence of the lower projections. During such operations, sipe members are forced into the tread during mold closure and out of the tread during mold opening. Accordingly, a progressive sipe mold member must be durable enough to withstand the loadings observed during molding and demolding operations, as well as for repeated use for multiple curing cycles.

One approach for providing a more durable progressive sipe mold member is to increase the thickness of each portion of the form corresponding to the various portions and projections of the sipe member. This, however, results in thicker sipes, which may not be optimum for tire performance. Accordingly, there is a need for a more durable progressive sipe mold member, which provides sufficiently thin sipes in a tire tread.

### SUMMARY OF THE INVENTION

Particular embodiments of the present invention include treads containing one or more progressive sipes that undulate along a sweep axis in a desired path, as well as methods and apparatus for forming such in treads. Particular embodiments of the present invention include a sipe mold member for use in a mold. Particular embodiments of such mold member include an upper mold member extending downwardly from a top end to a bottom end. Particular embodiments may also include a first lower projection member and a second lower projection member, each lower member extending downward from the initial extension. Further, particular embodiments provide the sipe mold member having a sweep axis along which the sipe mold member undulates in a desired path.

Particular embodiments of the present invention include a molded tire tread including a plurality of tread elements being separated by one or more grooves, and one or more progressive sipes. In particular embodiments, each sipe has a sweep axis along which the sipe undulates in a desired path. In particular embodiments, each such sipe includes a first and second lower sipe projection extending from an upper sipe portion, each of the projections being spaced apart from the other within the tread and extending to a depth within the tread.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 is a perspective view of an undulating sipe mold member, in accordance with an embodiment of the present invention.

FIG. 2 is a top view of the mold member of FIG. 1.

FIG. 3A is an end view of the mold member of FIG. 1 showing forces acting on such member during the closing of a mold prior to a curing cycle, according to an embodiment of the invention.

FIG. 3B is an end view of the mold member of FIG. 1 showing forces acting on such member during the opening of a mold subsequent a curing cycle, according to an embodiment of the invention.

FIG. 4 is a top view of a non-symmetrically undulating sipe mold member, in accordance with an alternative embodiment of the invention.

FIG. 5 is a top view of an undulating sipe mold member extending in a stepped path, in accordance with an alternative embodiment of the invention.

FIG. 6 is a top view of an undulating sipe mold member extending along an arcuate sweep axis, in accordance with an alternative embodiment of the invention.

FIG. 7 is a perspective view of a tread having a plurality of undulating sipes, in accordance with an embodiment of the present invention.

FIG. 8A is a sectional view of an undulating sipe contained within the tread of FIG. 4, in accordance with an embodiment of the invention.

FIG. 8B is a cross-sectional view of an alternative undulating sipe, in accordance with an alternative embodiment of the invention shown in FIG. 7A.

FIG. 8C is a cross-sectional view of an alternative undulating sipe, in accordance with an alternative embodiment of the invention shown in FIG. 7A.

FIG. 8D is a cross-sectional view of an alternative undulating sipe, in accordance with an alternative embodiment of the invention shown in FIG. 7A.

FIG. 9 is a graph showing the relative improvement (reduction) in maximum yield stress (i.e., Von Mises stress) σ_{y,u}/σ_{y,o} provided by an undulating mold member 10, for different amplitudes U_{A} of a sinusoidal path P. More specifically, the graph displays maximum relative stress reductions by comparing the stress σ_{y,o} of a non-undulated mold member to the stress σ_{y,u} of an undulating mold member 10, the cross-sectional shape and dimensions of each mold member being substantially the same. As generally shown, as the amplitude U_{A} of the waveform increases, the reduction in stress also increases, in accordance with an embodiment of the present invention.

FIG. 10 is a perspective view of a mold member comprising a progressive sipe mold member and a second sipe mold member, according to an alternative embodiment of the present invention.

### DETAILED DESCRIPTION OF PARTICULAR EMBODIMENTS

Particular embodiments of the present invention provide treads containing an undulating progressive tread feature or sipe, and methods and apparatus of forming the same.

A progressive sipe is a sipe that generally includes a pair of projections extending downwardly from an upper sipe portion positioned along a tread contact surface, at least one of the projections extending outwardly from the upper sipe portion. The tread contact surface is generally the portion of the tread extending about the outer circumference of a tire between the side edges of the tread. At least one of the pair of projections also extends outwardly or away from the other projection as each extends downwardly with increasing tread depth. In particular embodiments, the lower projections extend from an upper sipe portion having a length, the upper sipe portion extending downwardly from the contact surface of the tread to a particular depth within the tread. Lower projections may extend from a bottom end of upper sipe portion, or from any other location along the length of upper sipe portion. To form progressive sipes within a tread, a corresponding mold member is positioned within the mold to form a relief A progressive sipe mold member includes a corresponding member for each sipe extension. Generally, the sipe mold member forms a sipe having substantially the same cross-sectional shape, except that the mold member corresponding to upper sipe portion may extend further to form a means for attaching mold member into a mold.

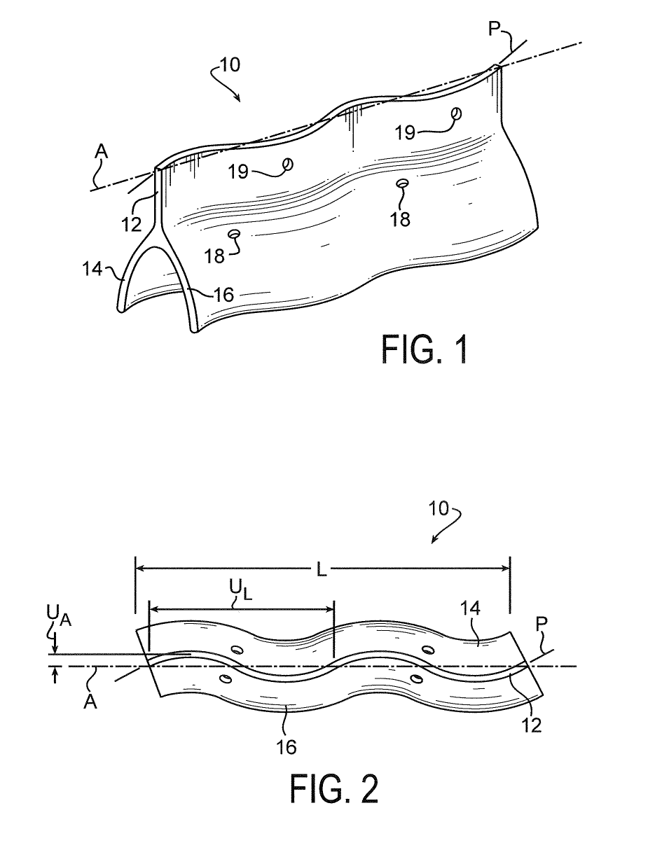

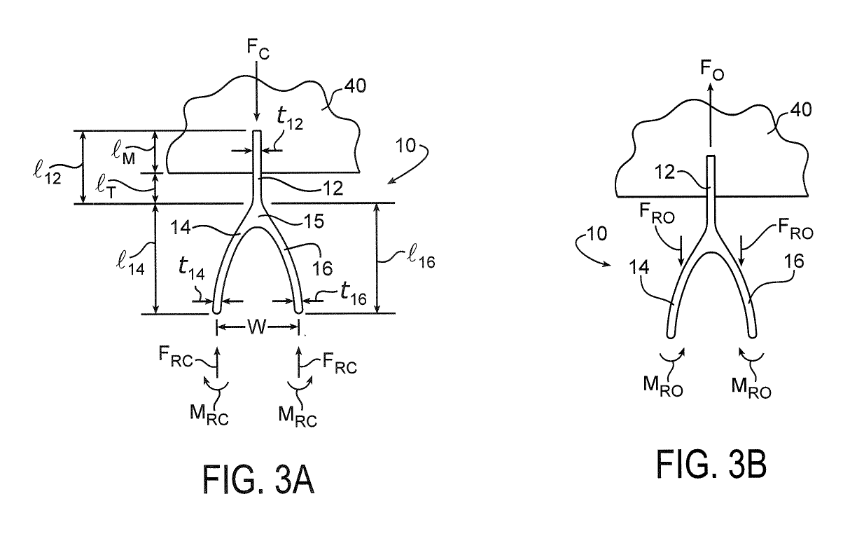

Progressive sipe mold member 10, shown in a particular embodiment in FIG. 1, includes an initial or upper sipe member 12, and a pair of first and second lower projection members 14 and 16 extending from upper member 12. As generally shown in FIG. 3A, lower members 14, 16 each have a corresponding length l ₁₄, l ₁₆ and extend outwardly to a width W. In the embodiments shown, upper sipe member 12 has a length l₁₂. With reference to FIG. 3A, length l₁₂ of upper sipe member 12 is equal to the sum of distance l_{M} and l_{T}, where distance l_{M} represents a distance by which upper sipe member 12 is inserted into a mold 40 and distance l_{T} represents the distance by which upper sipe member 12 is inserted into tread 20. Distances lₘ and l_{T} may be any desired value. For example, upper sipe member 12 may not extend into the tread, and, therefore, distances l_{T} would equal zero. In other words, upper sipe member 12 simply comprises the joint 15 between lower members 14, 16, such that upper sipe member 12 does not substantially extend upwardly beyond such joint 15. In the embodiments shown, each of the lower members 14, 16 extend from upper member 12 at a common instance, namely, at joint 15, at the bottom end of upper member 12. In other embodiments, however, it is contemplated that each of the lower extension members 14, 16 may extend independently from upper member 12, from the same or different position along length l₁₂ of upper member 12.

Conventional sipes, in comparison to progressive sipes, do not include a pair of lower projections. Accordingly, mold members for forming conventional sipes do not have lower extending members 14, 16, and instead generally comprise an elongated upper member 12. Accordingly, significantly less resistive forces are exerted on conventional sipe members during molding and demolding operations, since resistive forces are only exerted upon the very thin bottom end surface of the slit-like member, and any side surfaces that may exist when a conventional sipe member extends downwardly in a wavy (i.e., non-linear) path.

It follows that during molding and demolding operations, progressive sipe mold members 10 are exposed to substantially higher forces than those associated with conventional sipes. Because lower members 14, 16 extend outwardly, progressive sipe mold member 10 provides significantly more lateral surface area than a conventional sipe mold member against which a tread will apply forces and moments to resist mold member entry or extraction from such tread during mold closing and opening operations, respectively. Accordingly, significantly more force is applied against progressive mold member 10, as compared to a conventional sipe mold member.

For example, with reference to FIG. 3A, an exemplary embodiment of a progressive sipe mold member 10 is shown in cross-section during a mold closing operation. When a mold 40 is closed, such as prior to molding and/or curing of the tread, the sipe member 10 is forced by closing force F_{C} into tread material positioned within the mold. Accordingly, the tread material resists entry of the sipe member 10, which imparts resistive forces F_{RC} on the lower extensions 14 and 16 of mold member 10. Further, each of the lower extension members 14, 16 is subjected to a moment M_{RC}, which arises by virtue of each such lower member 14, 16 being cantilevered from upper member 12. Similarly, as shown exemplarily in FIG. 3B, the tread exerts resistive forces F_{RO} and moments M_{RO} against the lower members 14, 16 as the tread attempts to prevent the extraction of member 10 during a mold opening operation.

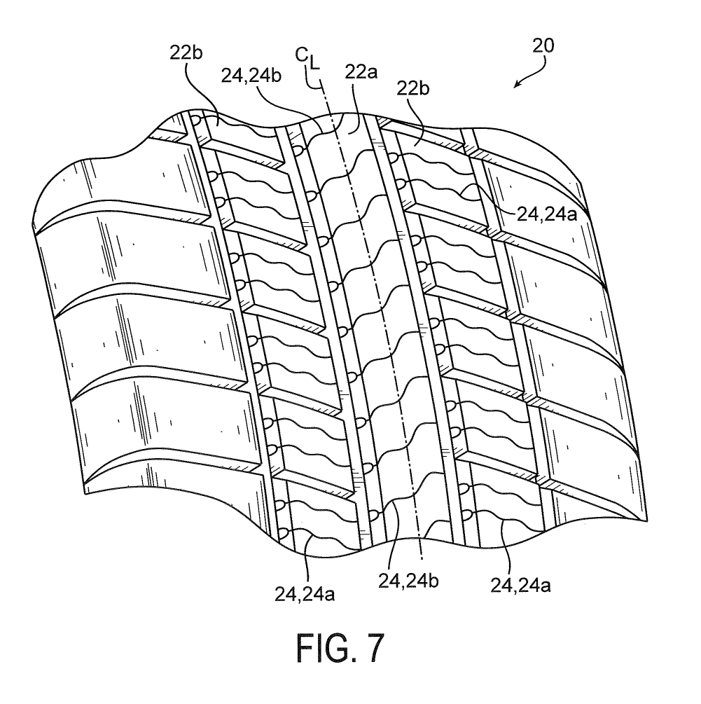

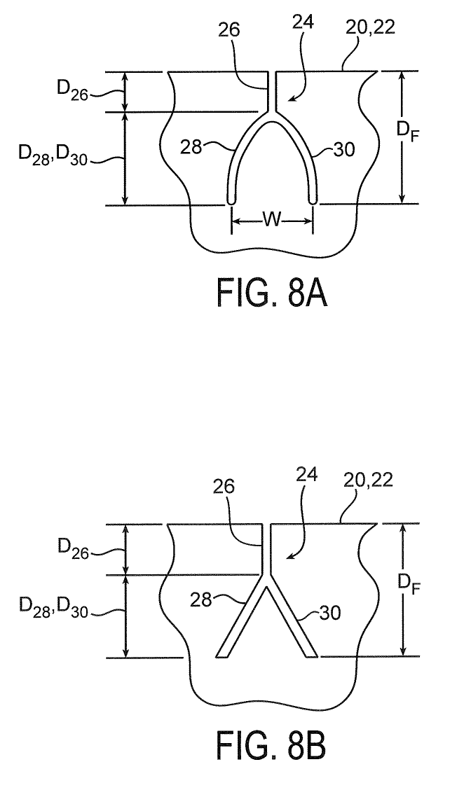

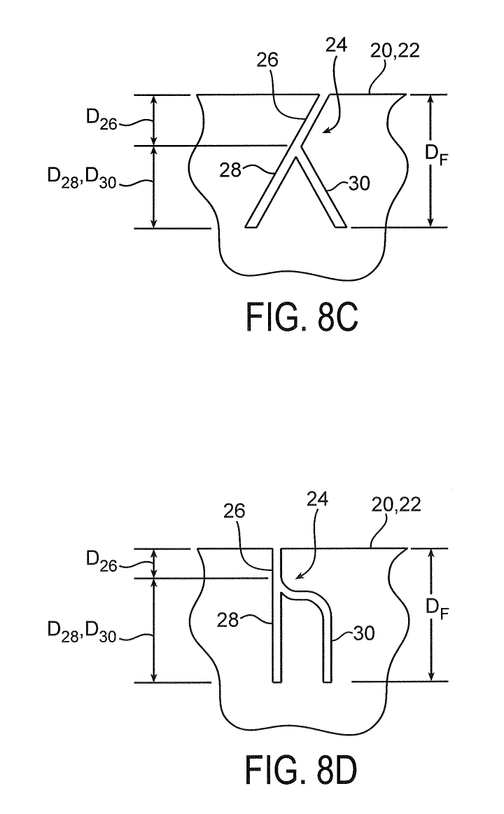

As exemplarily shown in FIGS. 1 and 2, to overcome the additional forces and stresses experienced by a progressive sipe mold member 10, such member 10 is strengthened by undulating the member 10 along its length L, relative to a sweep axis A extending in a generally lengthwise direction of member 10. In other words, sipe mold member 10, and any corresponding sipe 24 formed from member 10 (such as is shown, for example, in FIGS. 7-8D), alternates between opposing sides of a sweep axis A in any desired manner for a length L of the corresponding member 10 or sipe 24. Accordingly, member 10 extends along a path P, which extends along sweep axis A in an undulating or non-linear manner. With reference to FIG. 2, each undulation segment S extends along sweep axis A by a distance equal to one-half (½) the length U_{L}.

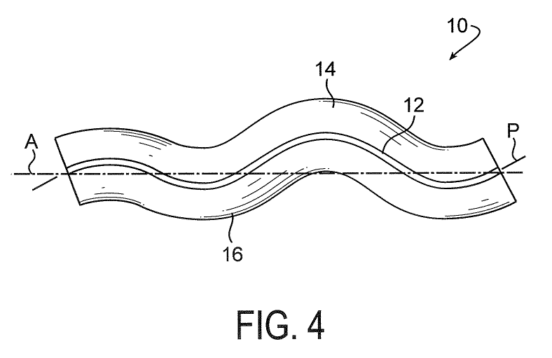

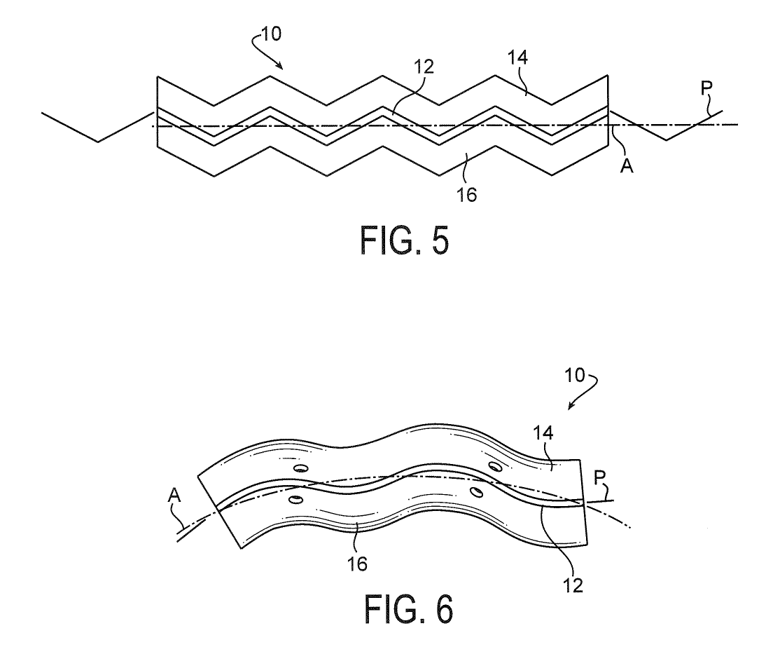

As shown in FIGS. 1 and 2, in particular embodiments, an undulating path P may be symmetrical about axis A. As shown in FIG. 4, however, it is contemplated that member 10 may extend along an undulating path P that is not symmetrical (i.e., asymmetrical) relative to sweep axis A. It is contemplated that undulating path P may extend as a smooth waveform or a contoured path, such is exemplarily shown in FIGS. 1, 2, and 4. For example, a waveform may comprise a sinusoidal wave having a periodic length that is equal to length U_{L}, and an amplitude equal to distance U_{A}. In other embodiments, undulating path P may extend in a stepped (i.e., jagged) path, which may be formed of linear or non-linear step undulation segments S. A linearly-stepped path P is exemplarily shown in FIG. 5. It is contemplated that an undulating path P may only exist or extend along a portion of a sipe mold member 10, and/or may be combined with differently undulating portions of sipe mold member 10. For example, a sipe member 10 may include intervals of contoured and stepped undulations. Further, the extension of path P may extend along length L in a consistent or uniform manner, as shown in FIGS. 1-2, or in an intermittent, variable, non-repeating, or arbitrary manner, meaning that the path P may undulate inconsistently or intermittently along path P.

Sweep axis A generally extends along a length L of a sipe member 10 or corresponding sipe 24. As generally shown in FIGS. 1-5, sweep axis A may be linear. In other embodiments, however, sweep axis A may extend in a non-linear direction, such as is shown in one embodiment in FIG. 6.

By providing undulating lower members 14, 16, each is better able to (i.e., more efficiently able to) withstand the forces exerted thereupon when mold member 10 is forced in and out of a tread during the molding process. Accordingly, it is contemplated that lower members 14, 16 may undulate while upper member 12 does not undulate. It is also contemplated that members 12, 14, 16 may undulate differently and independently, or together in any combination. Members 12, 14, 16 are shown in particular embodiments to undulate together in FIGS. 1, 2, and 4.

In one embodiment, a sinusoidal path P has a periodic length U_{L} of 10 mm and an amplitude U_{A} of 0.3 mm, 0.4 mm, or 0.6 mm. In other embodiments, the amplitude U_{A} is 0.3-0.6 mm, 0.4-0.6 mm. In still other embodiments, the amplitude U_{A} is at least 0.3 mm, at least 0.4 mm, or at least 3% of the periodic length U_{L}. According to a study, when the sinusoidal path P of a mold member 10 has a periodic length U_{L} of 10 mm and an amplitude U_{A} of 0.6 mm, it has been estimated that the maximum yield stress (i.e., Von Mises stress) was reduced by a factor of 2.5 when compared to the maximum yield stress of a non-undulating mold member having the substantially the same cross-sectional shape and dimensions. However, when reducing the amplitude U_{A} from 0.6 mm to 0.4 mm, the maximum yield stress was reduced by a factor 2.

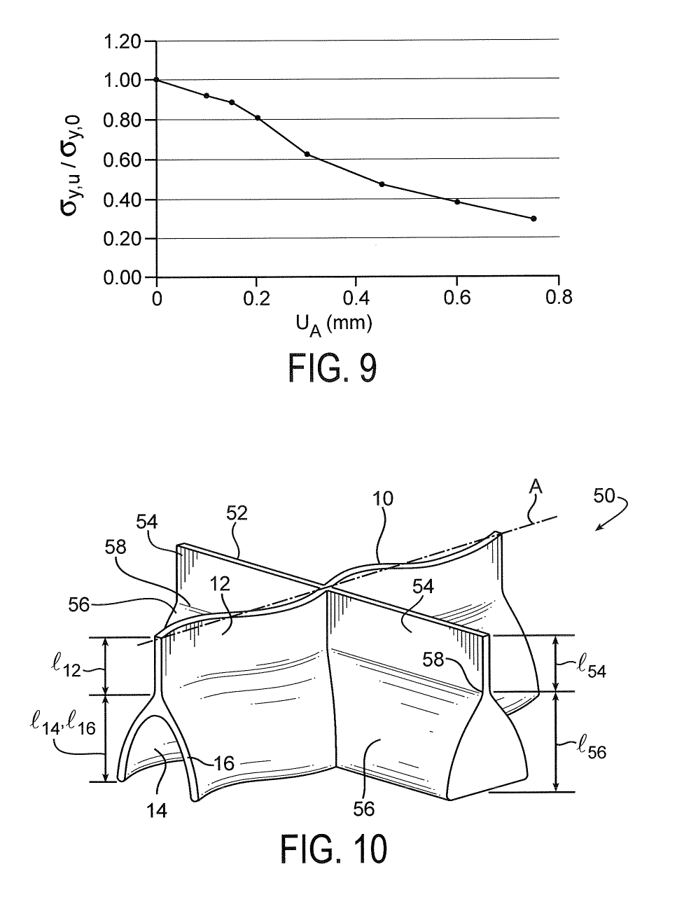

In FIG. 9, a graph more generally shows the relative improvement (reduction) in maximum yield stress (i.e., Von Mises stress) provided by an undulating mold member 10, for different amplitudes U_{A} of a sinusoidal path P. More specifically, the graph displays maximum relative stress reductions by comparing the stress of a non-undulated mold member to an undulating mold member 10, the cross-sectional shape and dimensions of each mold member being substantially the same. In the graph, the comparison of maximum yield stresses is represented by relative maximum yield stress σ_{y,u}/σ_{y,o}, which is equal to the maximum yield stress σ_{y,u} of an undulating sipe mold member 10 divided by the maximum yield stress σ_{y,o} of a non-undulating sipe mold member. As generally shown in FIG. 9, the reduction in stress increases as the amplitude U_{A} of the waveform increases.

By achieving increased strength and durability by reducing the stresses through undulations, the thickness t₁₂, t₁₄, and t₁₆ of respective undulating members 12, 14, 16 may be reduced to improve the performance of a resulting sipe in a tire tread, as well as the corresponding tire tread. With reference to the embodiment of FIGS. 3A and 3B, thicknesses t₁₂, t₁₄, and t₁₆ are shown. Such thicknesses may vary along the length L of member 10, and may vary between each other. In particular embodiments, any thickness t₁₂, t₁₄, and t₁₆ may be 0.4 mm or lower, and in other embodiments, 0.3 mm or lower, 0.2 mm or lower, and 0.1 mm or lower. In particular embodiments, any thickness t₁₂, t₁₄, and t₁₆ may be 0.05-0.4 mm, and in other embodiments, 0.05-0.3 mm or 0.05-0.2 mm. Further, with regard to width W, may extend any distance. In particular embodiments, width W is approximately equal to 3-8 mm, and in more specific embodiments, 5-6 mm.

To facilitate attachment of progressive mold member 10 into a mold, member 10 may include one or more attachment means. In particular embodiments, as exemplarily shown in FIG. 1, the upper portion of upper member 12 is an attachment means, as such may be inserted into the mold for securement, such as by welding. Further, an attachment means may also comprise one or more apertures 19 positioned along upper member 12 to facilitate the securement of aluminum or other metal about a portion of upper member 12 for welding member 10 within an aluminum mold. Any other attachment means known in the art may be used in addition to, or in lieu of, upper member 12 and/or apertures 19. Further, vents 18 may be included within any bottom member 14, 16 to facilitate the venting of air or rubber through a corresponding member 14, 16.

Undulated sipe mold members 10 are utilized to form corresponding progressive sipes 24 in a tire tread. With reference to FIG. 7, a representative tread 20 is shown having undulating progressive sipes 24 formed by similarly-shaped mold members 10. In the embodiment shown, progressive sipes 24 are formed within tread elements 22, which may comprise a rib 22a or a block 22b. Undulated sipes 24 may be used and oriented within a tread 20 in any manner desired to achieve a desired tread pattern. Accordingly, each sipe 24 may extend along its sweep axis A in any direction along a tread element 22, where such sweep axis A is linear or non-linear. In FIG. 7, for example, sipes 24 are provided along a tread in a particular embodiment, where sipes 24a extend along blocks 22b and sipes 24b extend along ribs 22a. More specifically, sipes 24a are shown to extend laterally along tread 20 in a direction approximately normal to the longitudinal centerline CL of tread 20, while sipes 24b extend laterally at a biased angle relative to the tread longitudinal centerline CL.

Sipe 24 may also extend circumferentially about a tire, where the length L of sipe 24, or of corresponding mold member 10, is equal to the length or circumference of the tread. Or, it can also be said that such sipe 24, or mold member 10, is continuous. In other embodiments, undulated sipes 24 may extend across a full width (or length) of a corresponding tread element 22, such as is exemplarily shown in FIG. 7, or, in other embodiments, a sipe 24 may extend along any portion less than the full width or length of any tread element 22.

With reference to FIGS. 8A-8D, an undulated sipe 24 generally extends to any depth D_{F} into the depth of a tire tread. In particular embodiments, such as those shown in such figures, undulated sipe 24 may comprise an upper or initial portion 26, which corresponds to initial or upper member 12 of mold element 10. As with upper member 12, it is contemplated that upper portion 26 may or may not undulate. Undulated sipe 24 also includes first and second lower projections (i.e., legs) 28, 30, each of which correspond to first and second mold members 14, 16, respectively. In particular embodiments, upper portion 26 extends downwardly from an exterior tread surface to a desired tread depth D₂₆. Depth D₂₆ corresponds to length l₁₂ of an associated mold member 10. While depth D₂₆ may comprise any distance, it is also contemplated that depth D₂₆ may be substantially zero, such that joint 15 extends along the tread surface. With regard to lower projections 28, 30, each such projection extends a depth D₂₈ and D₃₀, respectively, into the tread. Such projections 28, 30 may extend to the same tread depth as shown in the figures, or, in other embodiments, may each extend to different depths within the tread.

With regard to the cross-sectional shape of progressive undulated sipe 24, any shape is contemplated. With general reference to the embodiments of FIGS. 8A-8D, the cross-sectional shape of a progressive sipe 24 can be generally described as being an inverted “Y” or “h”. Still, it is contemplated that any other shape or variation can be used, and, accordingly, is within the scope of this invention. For example, with reference to the embodiment shown in FIG. 8A, the cross-section of sipe 24 shown can also be referred to as forming a wishbone shape. Further, lower projections 28, 30 generally form an inverted “U” or “V” shape. It follows that sipe 24 may form a “U” or “V” shape when upper portion does not exist, or when it has a small or negligible length. With reference to the embodiments shown in FIGS. 8B and 8C, the cross-sections of sipe 24 shown can also be referred to as forming lower case and upper case inverted “Y” shapes, respectively. With reference to FIG. 8D, the cross-section shown can also be referred to as forming a lower case “h” shape. The cross-sectional shape of sipe 24 maybe symmetrical, as exemplarily shown in FIGS. 8A and 8B, or asymmetrical, as exemplarily shown in FIGS. 8C and 8D. Because undulated sipe 24 is formed by a corresponding mold member 10, it follows that any variations in shape or design, including the manner or path of undulation, for either sipe 24 or member 10 corresponds to the other. Accordingly, the discussion with regard to mold member 10, as well as associated members 12, 14, 16, is incorporated within regard to sipe 24 and its projections 26, 28, 30, and visa versa. Accordingly, just as sipe mold member 10 has a sweep axis A, the corresponding sipe 24 formed by such mold member 10 also extends along the same (has a corresponding) sweep axis A.

In operation, upper projection 26 provides an initial sipe incision along the tread surface, which can be seen in FIG. 7. After the tire tread has been worn to a particular depth, the upper sipe incision is worn away by a depth D₂₄ to leave exposed a pair of spaced-apart sipe incisions associated with first and second projections 28, 30. It is contemplated that, however, sipe mold member 10 may be arranged such that only the first and second lower mold members 14, 16 are contained within tread 20, which means that only first and second projections 28, 30 would be contained within an unworn tread. In other words, distance l_{T}, as shown in FIG. 3A, would be equal to zero.

With reference to FIG. 10, another embodiment of the present invention is shown. It is contemplated that an undulated sipe 24 may intersect any other tread feature, such as another groove or sipe, for example. In FIG. 10, a multi-feature mold member 50 is shown. The multi-feature member 50 generally includes an undulated sipe mold member 10 intersecting a second tread feature mold member 52. Undulating mold member 10 may comprise any embodiment contemplated above, and may intersect second mold member 52 at any angle of incidence. Second mold member 52 may form a groove or sipe, which may extend in any direction along a tread. For example, second mold member 52 extends in any circumferential direction along a tread. In the particular embodiment shown in FIG. 10, second mold member 52 generally includes an upper mold portion 54 and a lower mold portion 56, the lower portion 56 extending from upper portion 54 at location 58 while also expanding widthwise from the upper mold portion 54 (i.e., the lower portion 56 is wider than the upper mold portion 54). In the embodiment shown, lower portion 56 forms a single oblong or tear-drop shaped form, which may have an outer shape similar to that formed by the pair of lower projection members 14, 16 of member 10, or, in other embodiments, lower portion 56 may for any other desired shape. In other embodiments, second mold member 52 may comprise a second undulating mold member 10, or a conventional sipe, which generally comprises an elongated upper portion 54, which may extend downwardly any distance, where such downward extension may be linear or non-linear.

As shown in the embodiment of FIG. 10, upper mold portion 54 extends a distance l₅₄ between a top and a bottom of such mold portion 54, while bottom mold portion 56 extends a distance l₅₆ between a top and a bottom of such mold portion 56. In particular embodiments, upper mold portion distance l₅₄ equals at least 2 mm, and the lower wear layer formed by lower mold portion 56 in a tread becomes exposed after distance l₅₄ is worn away. In other embodiments, any other desirable distances for distance l₅₄ and distance l₅₆ may be used. Further, while lower projections 14, 16 of progressive sipe mold member 10 and lower mold portion 56 of second mold member 52 as shown in FIG. 10 to extend (or initiate) from similar locations along corresponding members 10 and 52 (i.e., locations 15 and 58 are similarly positioned along the height of member 50), in other embodiments, lower projections and lower mold portion 56 may begin to extend (initialize) at different locations along the height of member 50. Finally, the projections lengths l₁₄, l₁₆ and lower portion length l₅₆ may be the same, as shown in FIG. 10, or different, in other embodiments.

While this invention has been described with reference to particular embodiments thereof, it shall be understood that such description is by way of illustration and not by way of limitation. Accordingly, the scope and content of the invention are to be defined only by the terms of the appended claims.

What is claimed:

1. An undulating sipe mold member for use in a mold comprising:
an upper mold member extending downwardly from a top end to a bottom end; and,
a first lower projection member and a second lower projection member, each lower member extending downward from the initial extension,
the sipe mold member having a sweep axis along which the sipe mold member undulates in a desired path.

2. The mold member of claim 1, wherein the undulating path is an alternating path.

3. The tire tread of claim 1, wherein the undulating path is a contoured path.

4. The mold member of claim 1, wherein the undulating path is symmetrical about the lengthwise sweep axis.

5. The mold member of claim 1, wherein the lengthwise sweep axis is non-linear.

6. The mold member of claim 1, further comprising an attachment means for attaching the sipe to a mold.

7. The mold member of claim 1, wherein the first and second lower projection members form a symmetrical cross-sectional shape.

8. The mold member of claim 1, wherein the first and second lower projection members form a “U” or “V” cross-sectional shape.

9. The mold member of claim 1, wherein the sipe mold member generally forms an inverted “Y” of “h” cross-sectional shape.

10. The mold member of claim 1, wherein the sipe mold member intersects a groove mold member or second sipe mold member.

11. The mold member of claim 10, wherein the second sipe mold member includes an upper mold portion and a lower mold portion, the lower mold portion expanding widthwise from the upper mold portion.

12. The mold member of claim 11, wherein the lower expanded mold portion forms a single projection.

13. A molded tire tread comprising:
a plurality of tread elements being separated by one or more grooves;
one or more progressive sipes, each sipe having a sweep axis along which the sipe undulates in a desired path, each sipe also including:
a first and second lower sipe projection extending from an upper sipe portion, each of the projections being spaced apart from the other within the tread and extending to a depth within the tread.

14. The tire tread of claim 13, wherein the upper sipe portion extends from an exterior tread contact surface to a final depth within the tread, the first and second extensions extending from the upper sipe portion.

15. The tire tread of claim 13, wherein the undulating path is an alternating path.

16. The tire tread of claim 13, wherein the undulating path is a contoured path.

17. The tire tread of claim 13, wherein the undulating path is symmetrical about a lengthwise sweep axis.

18. The tire tread of claim 13, wherein the lengthwise sweep axis is non-linear.

19. The tire tread of claim 13, wherein each of the first and second projections extend to a different depth within the tread.

20. The tire tread of claim 13, wherein the first and second lower projections form a symmetrical cross-sectional shape.

21. The tire tread of claim 13, wherein the first and second lower projections form a “U” or “V” cross-sectional shape.

22. The tire tread of claim 13, wherein the undulating sipe generally forms an inverted “Y” or “h” cross-sectional shape.

23. The tire tread of claim 13, wherein the progressive sipe intersects a groove or second sipe.

24. The tire tread of claim 23, wherein the second sipe includes an upper portion and a lower expanded portion.

25. The tire tread of claim 24, wherein the lower expanded portion comprises a pair of lower projections.
